(19) United States
(12) Patent Application Publication
(10) Pub. No.: US 2011/0040604 A1
(43) Pub. Date: Feb. 17, 2011

(54) Systems and Methods for Providing Targeted Content

(75) Inventors: Paul Edward Kaib, Atlanta, GA (US); Brent Allen Walker, Marietta, GA (US); Joshua Michael Hofmann, Atlanta, GA (US); Gregg S. Freishtat, Atlanta, GA (US); Kevin Bryant Holcom, Atlanta, GA (US)

Correspondence Address: SUTHERLAND ASBILL & BRENNAN LLP, 999 PEACHTREE STREET, N.E., ATLANTA, GA, 30309, US

(73) Assignee: VERTICAL ACUITY, INC., Atlanta, GA (US)

(21) Appl. No.: 12/647,304

(22) Filed: Dec. 24, 2009

Related U.S. Application Data
(60) Provisional application No. 61/233,649, filed on Aug. 13, 2009.

(51) Int. Cl. G06Q 10/00; G06Q 30/00; G06F 15/18; G06F 3/048; G06F 15/16

(52) U.S. Cl. 705/10; 705/347; 706/12; 715/760; 709/224

(57) ABSTRACT

Systems and methods for providing targeted content to a network user. In one embodiment, a method for providing targeted content to a consumer via a network during the consumer's viewing of a webpage can be provided. The method can include aggregating data from one or more of the following: crawled webpage data, vertical clickstream data, and previously stored webpage visitation data. The method can further include determining one or more trends associated with an industry vertical based at least in part on some of the aggregated data. Further, the method can include determining at least one content recommendation for the consumer based at least in part on one or more trends associated with an industry vertical. Moreover, the method can include outputting the at least one content recommendation to the consumer via the webpage.

### RELATED APPLICATION

This application claims priority to U.S. Ser. No. 61/233,649, entitled “Systems and Methods for Providing Targeted Content”, filed Aug. 13, 2009, the contents of which are hereby incorporated by reference.

### FIELD OF THE INVENTION

The invention generally relates to analyzing consumer behavior and content on a network, and more particularly, to systems and methods for providing targeted content to a network user.

### BACKGROUND OF THE INVENTION

The Internet continues to provide access to a nearly endless supply of new content and websites, which will continue to grow exponentially for the foreseeable future. This content growth is problematic for destination sites, content owners, and consumers.

For destination sites, there is increased competition for acquiring and retaining consumers. Many consumers rely on several favorite destination sites and/or frequent use of one or more search engines to discover desired content. Thus, destination sites must continually produce and/or acquire relevant content and convincingly present such content to their consumers. Search engines can be effective and are popular among consumers, however, such search engines are an intermediate step between the consumer and their desired content.

For content owners, there is difficulty in distributing and monetizing their content to increasing numbers of sites and audiences. To maximize potential revenue and profit, content owners must reach as large of an online audience as possible. In some instances, content owners must establish direct relationships with other destination sites or use conventional media or content distributors. Establishing and maintaining such relationships can be time consuming and expensive, and not every possible audience segment may be reached at any given time.

For consumers, it is increasingly difficult to discover all content the consumer really wants. Typically, consumers must “bounce” or otherwise surf between known destination sites, search results pages, or engage in numerous searches to find content they want. For many consumers, finding relevant content can be time consuming.

Conventional systems and methods for providing content to website consumers have relied on a variety of technologies and approaches, which in many instances, have yielded less than successful and often times inconsistent results.

Since certain Internet advertising companies pioneered particular areas of contextual and behavioral targeting of advertising, the Internet industry has continually debated which targeting approach is more valid as particular companies begin to leverage these techniques to better target and recommend website content to site visitors. The reality is one or multiple models may be appropriate depending on the industry or content being consumed, versus relying on one particular approach. Various websites continue to implement technologies that give consumers more choices on what items they should click on next. Example links from section labels such as “Most Popular Stories”, “People Who Read This Also Read This”, “Related Content”, or “Most Commented” are often used as a next step. One goal of targeting content is to better predict consumer preference and demand for content, and then provide consumers with content they will find more interesting. Conventional systems and methods described above have several drawbacks and limitations.

Conventional contextual targeting utilizes keyword frequency to find additional content that includes mentions of primary subjects in an article: If an article is written about “Bernie Madoff”, contextual targeting will locate more content on “Bernie Madoff” based on the number of times “Bernie Madoff” is mentioned in additional articles, and then recommend content containing his name. The more times “Bernie Madoff” is mentioned, the higher the relevancy score for the article. A typical news site may have, for instance, 20 to 30 prior articles about “Bernie Madoff”, so a conventional system may select certain articles based on relevancy and publish date (newer articles versus older). Direct measurement of prior time spent with “Bernie Madoff”-related content is not used in this approach to identify content that performs well within the news industry because direct measurement of all “Bernie Madoff”-related content articles may be needed, for example in a particular sample, identifying which of the 30 articles written about “Bernie Madoff”, performed in the top 25% for consumer time spent with this content.

Conventional behavioral targeting of content utilizes selected additional content that other users have read based on commonalities in a navigational path. One conventional system utilizes collaborative-type filtering to accomplish this with its product recommendations. For example, if 20 users navigate from webpage A to webpage B, webpage B will be recommended on webpage A more frequently because it is navigated to more frequently. While this works well for certain websites with a particular scale and catalog depth, one problem with this approach as it relates to news and article related content is that whatever content is posted on a home page or is marketed as “popular” may tend to get recommended by users more because most consumers or users may only click on links from the home page. Thus recommending what may be popular on a particular day may inhibit or otherwise prevent keeping consumers or users engaged with a broader set of article content.

Conventional web analytics provided by particular companies can utilize certain data collected from a single web site to determine which aspects of the website work towards their business objectives. For example, some entities measure which content categories receive the most clicks by consumers or users. In turn, website owners using a content management system can use this data or clickstream to manually identify, tag, and deliver content they think consumers or users want. However, tagging content is often a manual process and fraught with user error, and in some instances content can be mis-categorized. Certain types of conventional analytics and automated tagging technologies may analyze a website's content at the subject level, and provide those websites with new views of how their content performs in comparison with their industry to identify new content needs. While several entities focus on web measurement at the industry level, in most instances, these entities fail to provide industry data about the content within and across those websites.

Thus, conventional systems and methods focus either on website traffic statistics (at the site level), such as site rankings, the growth rate and consumer sentiment around specific keywords, which in some instances may not be useful or particularly relevant measures of consumer interest in or demand for specific content, or utilize a purely contextual or behavioral approach to target content to consumers. Therefore, a need exists for systems and methods for providing targeted content to a network user.

### SUMMARY OF THE INVENTION

Embodiments of the invention can provide some or all of the above needs. Certain embodiments of the invention can provide systems and methods for providing targeted content. Other embodiments of the invention can provide systems and method for providing targeted content to a customer via a network of sites containing similar content. Yet other embodiments can provide systems and methods for providing targeted content to a consumer via a network during the consumer's viewing of a webpage.

In one embodiment, certain systems and methods for providing targeted content can combine contextual and behavioral targeting approaches with cross-site measurement of individual subjects, topics or brands. In this manner, such systems and methods can improve the quality and quantity of content on their websites and better monetize their content. By developing relatively comprehensive dictionaries that may be unique to specific verticals and normalizing each subject's performance, certain embodiments of the invention can also identify content within an industry vertical that performs higher than industry averages, in a given context, using particular metrics such as time spent, completion rate, contextual relevance, and page view velocity. By analyzing relatively large quantities of data across related sites and normalizing this data with one or more vertical dictionaries, certain embodiments can accurately predict what any given consumer on any given site in the network is likely to consume next—regardless of where in the network that specific content is located.

While conventional technologies have tried to develop broad ontologies that address every possible vertical, developing such ontologies can be expensive and time consuming. For instance, the music industry has millions of artists and albums, and developing a comprehensive ontology for this particular vertical would be very expensive and time consuming. Without deep ontologies in specific verticals, it is difficult for certain websites to leverage content to meet specific users needs and interests because the performance of these subjects and their related verticals is not currently tracked against other websites and/or there is insufficient data to make accurate prediction or analysis. Certain embodiments of the invention can also assist content publishers in improving their targeting and monetization of their content on other sites, not controlled by them and with whom they have no direct business relationship, by leveraging trend data to target content based on both consumer behavior, as well as the contextual relevance of the subjects being measured within the content articles. Furthermore, by directly measuring subject and topic level performance across websites that contain related content, the same data that is collected by these measurement companies at the website level can be applied to individual products and brands creating an entirely new opportunity for recommending and/or syndicating content by and between sites containing related content.

For example, in one embodiment, a health website that specializes in content about healthcare and diagnosis of specific ailments might have 25 articles on swine flu generally but no articles pertaining to the number of cases diagnosed in the Southeastern U.S. over the past 30 days. In one embodiment of the invention, certain network data can be combined with at least one vertical dictionary to provide an indication that certain consumers on this health website may very likely view an article concerning the number of swine Flu cases diagnosed in the Southeastern U.S. over the past 30 days if presented with that option. To determine what content is most likely to be consumed by any given consumer on any given site at any given point in time, data from across a larger network or related sites can be analyzed and content from those sites can be made available to any given consumer on any given site in the network. In the absence of using embodiment of the invention, sites may continue to plan in a relative vacuum by using only their own data. Website owners may not know they are missing relatively valuable content or products if they have no way to measure it or legally obtain it.

In another embodiment, certain systems and methods for providing targeted content can negotiate one or more content provider metrics with one or more destination site metrics to determine associated content to transmit to at least one destination site for viewing by at least one consumer. In this manner, such systems and methods can improve how content providers and destination sites obtain or otherwise share revenue for legally transmitting content to consumers both on sites they control and other sites in the network with whom they have no existing business or technology relationship.

For example, in one embodiment, a content provider such as a local blog that has a recent picture or article depicting flooding in Atlanta, Ga. may want to publicize the picture or article with one or more destination sites, such as local or national news organizations' websites. In certain instances, the content provider can associate one or more provider metrics, such as price and attribution with the picture, and if the content metrics suitably compare with one or more consumer metrics provided by the destination sites, then the picture can be transmitted to the destination sites for viewing by consumers. In other instances, the provider metrics and consumer metrics can be automatically negotiated, and then the picture can be transmitted to the destination sites for viewing by consumers. In any instance, certain embodiments of the invention can improve utilization of consumer demand for the picture or other associated content, which can drive how revenue is ultimately generated, obtained or otherwise shared for such content.

In one embodiment, a method for providing targeted content to a consumer via a network during the consumer's viewing of a webpage can be provided. The method can include aggregating data from one or more of the following: crawled webpage data, vertical clickstream data, and previously stored webpage visitation data. The method can further include determining one or more trends associated with an industry vertical based at least in part on some of the aggregated data. Further, the method can include determining at least one content recommendation for the consumer based at least in part on one or more trends associated with an industry vertical. Moreover, the method can include outputting the at least one content recommendation to the consumer via the webpage.

In another embodiment, a system for providing targeted content to a consumer via a network during the consumer's online use of a webpage can be provided. The system can include one or more processors operable to execute instructions to aggregate data from one or more of the following: crawled webpage data, vertical clickstream data, and previously stored webpage visitation data; based at least in part on some of the aggregated data, determine one or more trends associated with an industry vertical; based at least in part on some of the one or more trends, determine at least one content recommendation for the consumer; and output the at least one content recommendation to the consumer via a webpage.

In another embodiment, a method for providing targeted content to a customer via a network can be provided. The method can include receiving behavioral data associated with network use by a plurality of users. The method can also include receiving contextual data associated with network use by the plurality of users' network use. Further, the method can include identifying at least one trend within a vertical based at least in part on the behavioral data and the contextual data. Furthermore, the method can include determining a recommendation for at least one of the plurality of users, wherein the recommendation comprises content from a webpage accessible via the network.

In yet another embodiment, a system for providing targeted content to a consumer via a network can be provided. The system can include a processor operable to execute computer-readable instructions, and a memory comprising computer-readable instructions. The computer-readable instructions can be operable to receive at least one provider metric from a content provider; based at least in part on the at least one provider metric, determine associated content to transmit to at least one destination site; and transmit the associated content to the at least one destination site for viewing by at least one consumer.

Other systems and processes according to various embodiments of the invention will become apparent with respect to the remainder of this document.

### BRIEF DESCRIPTION OF THE DRAWINGS

Reference will now be made to the accompanying drawings and exhibits, which may not necessarily be drawn to scale, and wherein:

FIG. 1 illustrates a schematic view of an example data flow in accordance with an embodiment of the invention.

FIGS. 2-3 illustrate example presentations of data in accordance with embodiments of the invention.

FIG. 4 illustrates another example data flow in accordance with an embodiment of the invention.

FIGS. 5-7 illustrate example methods in accordance with an embodiment of the invention.

FIG. 8 illustrates an example system in accordance with an embodiment of the invention.

### DETAILED DESCRIPTION OF EMBODIMENTS

The invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will convey the scope of the invention. Like numbers refer to like elements throughout.

As used herein, the term “vertical” should be construed to describe any group related by industry, containing similar content on a website or market place. Thus, the term “vertically associated websites” should be construed to mean a group of websites with content related to same industry, topics, brands, or market place.

The term “content” should be construed to describe any form of data or information presented by, posted on, or otherwise accessible from a webpage, video player, audio player, or website.

The term “dictionary” and its pluralized form should be construed to describe any collection of data, information, text, alphanumeric text, words, phrases, keywords, keyphrases, terms, industry-specific words, market place-specific words, vertical-specific words, or new words within an industry, market place, or vertical.

The term “metric” and its pluralized form should be construed to describe any characteristic or attribute associated with distributing content. Example metrics can include, but are not limited to, an attribution, a price, a rate, a duration, a location, a content licensing term, or at least one business rule.

The terms “consumer” and “visitor”, and their pluralized forms should be construed to cover any entity or person accessing or otherwise requesting content from a webpage or a website.

The term “content provider” and its pluralized form should be construed to cover any entity or person generating, creating, collecting, or otherwise facilitating content for distribution to consumers via a webpage or website.

The terms “site”, “destination site”, “website”, “destination website”, and their pluralized forms should be construed to cover any webpage or website which a consumer or visitor visits or accesses via a network either by computer, mobile device, or other device connected to the Internet.

The term “computer-readable medium” describes any form of memory or a propagated signal transmission medium. Propagated signals representing data and computer-executable instructions can be transferred between network devices and systems.

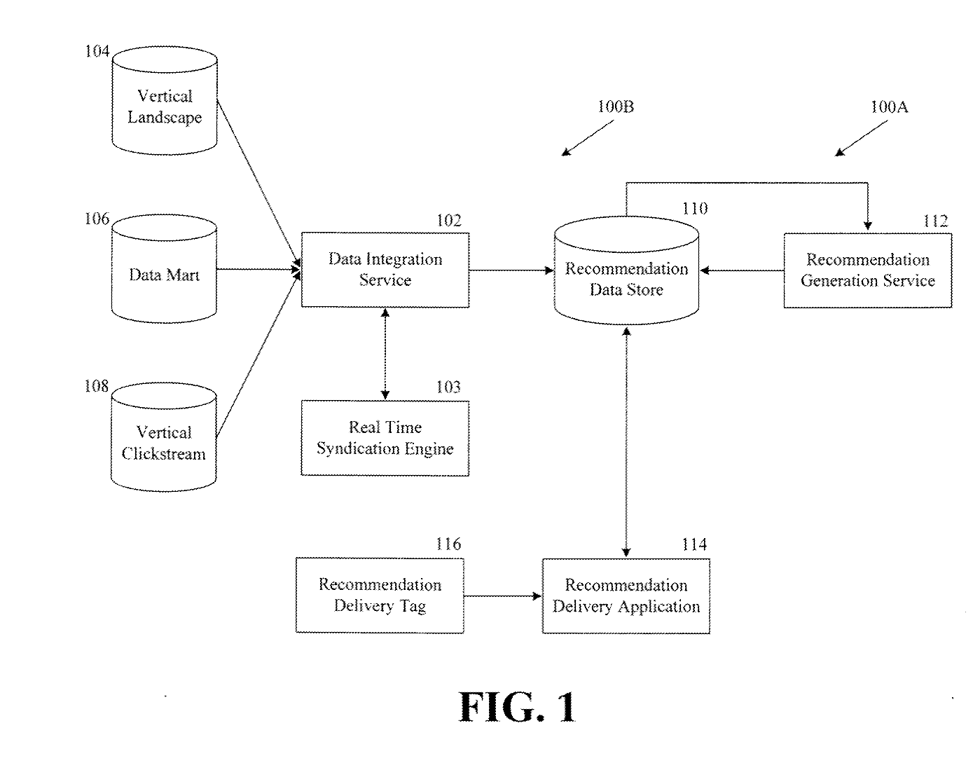

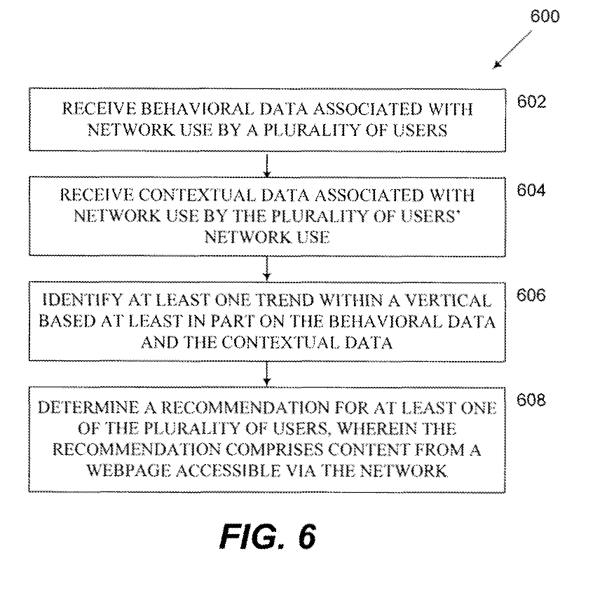

FIG. 1 illustrates a schematic view of an example data flow in accordance with an embodiment of the invention. The data flow 100A can facilitate providing targeted content. Unexpected improvements in providing targeted content can be achieved by way of various embodiments of the data flow 100A described herein. The data flow 100A is shown by way of example, and in other embodiments, similar or different data flow components, data flow inputs, and data flow outputs may exist. In the example shown in FIG. 1, the data flow 100A can be facilitated by a system 100B with at least one data integration service module 102. In certain embodiments, the system 100B can be referred to as a promotion delivery/targeting system. Data handled or otherwise received by the data integration service (DIS) module 102 can include any number of and different types of data streams and data sources, such as crawled webpage data from a vertical landscape mart 104, stored data from a datamart 106, and click data from a vertical clickstream mart 108. In certain embodiments, the data flow 100A and system 100B can operate in conjunction with the data flow and system described in FIG. 6 as well as in co-pending U.S. application Ser. No. 12/367,968, entitled “Systems and Methods for Identifying and Measuring Trends in Consumer Content Demand Within Vertically Associated Websites and Related Content,” filed Feb. 9, 2009, the contents of which are hereby incorporated by reference.

The vertical landscape mart 104 shown in FIG. 1 can be, for example, a data storage device with data previously collected from one or more web crawlers instructed to crawl a portion of, a specified portion of, or all of a website. For example, one or more URL (uniform resource locator) fragments or similar network location information can be identified to be crawled within one or more websites within a specific vertical. In this example, some or all of the keyword instances located by the subsequent search of the content retrieved by the web crawler in a crawl of the associated webpages of the selected websites can be stored in a vertical landscape mart 104 or other data storage device. Various keyword characteristics can also be collected and stored including, but not limited to, the number of occurrences of each keyword, and the location of those occurrences by URL.

In at least one embodiment, multiple vertical landscape marts or data storage devices, similar to 104, can be implemented in the data flow 100A or by the system 100B, wherein each vertical landscape mart or data storage device can be associated with a respective vertical.

In another embodiment, a single vertical landscape mart 104 or data storage device can be organized by way of one or more verticals, wherein each vertical can include one or more website URLs for associated entities within the respective vertical.

The datamart 106 shown in FIG. 1 can be, for example, a data storage device or a database where previously stored final, combined data sets are stored. The data sets in the data mart 106 or similar data storage device can be accessed by any number of application programs including, but not limited to, a reporting engine operable to generate one or more reports with data associated with at least one of the stored datasets. For example, a reporting engine associated with a data integration service module, such as 102, can access one or more data sets in the data mart 106.

In another embodiment, multiple datamarts, similar to 106, can be implemented with a data flow 100A or system 100B. In one example, a reporting engine associated with a data integration service module, such as 102, can access one or more data sets in multiple data marts similar to 106.

The vertical clickstream mart 108 shown in FIG. 1 can be, for example, a data storage device with previously stored or collected click session data. Using any number of collection and/or tracking processes and/or associated devices, click session data associated with one or more consumers can be obtained or otherwise received by a vertical clickstream mart such as 108. In the embodiment shown in FIG. 1, at least one tracking and recording application module associated with a data integration service module, such as 102, can be implemented to receive and interpret data from one or more V-tags, such as a tracking tag. The data from one or more V-tags can be stored by the tracking and recording application module in the vertical clickstream mart such as 108. A V-tag can be JavaScript™ or similar code that can be pre-placed or otherwise encoded on any webpage where consumer tracking is desired. After a webpage with a V-tag, such as a tracking tag, is loaded by a consumer's Internet browser program, the tracking tag can load additional JavaScript™ or similar code, also known as “server side code”, in the background after the webpage has fired. In at least one embodiment, loading of the additional JavaScript™ or similar code can be relatively fault tolerant in the event one or more servers are unable to service the request, such that a consumer's experience on the website of interest is not impacted or otherwise interrupted. The additional JavaScript™ or similar code can record one or more session variables associated with a consumer's interactions with the website. Examples of session variables can include, but are not limited to, the URL of a webpage a consumer is viewing, the URL of a webpage a consumer navigated from, the engagement time in seconds for each webpage view and any searches a consumer performs using a website or webpage.

In another embodiment, multiple vertical clickstream marts, similar to 108, can be implemented with a data flow 100A or system 100B. In one example, a tracking and recording application associated with a data integration service module, such as 102, can store data from one or more V-tags or other tracking tags in multiple vertical clickstream marts similar to 108.

In the embodiment shown in FIG. 1, one or more processors associated with the system 100B, such as a processor associated with the data integration service module 102, can identify various keyword, or subject, occurrences within web pages utilizing one or more dictionaries of industry related subjects in conjunction with natural language processing techniques. Furthermore, one or more processors associated with the system 100B, such as a processor associated with the data integration service module 102, can facilitate measuring consumer traffic to the web pages where those subjects were found using JavaScript™ tags. One or more processors associated with the system, such as a processor associated with the data integration service module 102, can utilize a variety of techniques and/or algorithms, such as at least one machine-based learning algorithm, to combine both the resulting data from the identification of subject occurrences with the consumer traffic data to the corresponding web pages where those subjects were located. This integration can allow trend data around a specific subject to be aggregated across multiple websites, or a vertical category across those websites. Examples of suitable trend data which can be aggregated or otherwise determined can include, but are not limited to:
a. Occurrence—how many times does a product or brand appear and on what types of sites and pages;
b. Geographies—in which geographic locations is a specific product or brand most popular based on consumer views of that product;
c. Velocity—what is the growth rate of a product or brand being mentioned, as well as consumed (actual page views), and on what types of pages;
d. Engagement—how many seconds does a consumer remain engaged with a product or brand across all web pages where that product or brand occurred;
e. Reach—how many consumers is a product or brand reaching during a given period of time based on actual page views containing the product or brand; and
f. Location—what types of web pages and sites does a brand or product perform the best based on increases in page views or engagement time.
g. Co-Relevance—what other recognized terms or subject are found in close proximity or within the same clickstream.

The data integration service module 102 shown in FIG. 1 can also include a real time syndication (RTIS) engine or application program 103. The RTIS engine 103 can monitor and analyze the resulting trend data within a particular vertical using at least one machine-based learning algorithm to understand what specific subjects and related subject content may be performing above industry or vertical averages for each subject or topic. Once the RTIS engine 103 determines or otherwise understands the most popular or relevant subjects, popular or relevant page content associated with those subjects, and the type of visitor consuming that content using the available trend data, the RTIS engine 103 can identify and generate one or more recommendations of specific content to respective visitors based at least in part on the real time popularity of the subjects contained in whatever article or content the visitors are reading. For instance, each visitor can be presented with the article or content he or she is most likely to act on based at least in part on the aggregated network trends associated with each subject.

One or more recommendations generated by the RTIS engine 103 can be stored in a data storage device, such as a recommendation data store 110 shown in FIG. 1. In the embodiment shown in FIG. 1, a recommendation generation (RG) service module or application 112 can continually generate or otherwise provide new and/or updated recommendations based on new and/or updated data from the RTIS engine 103. The new and/or updated recommendations can also be stored in a data storage device, such as a recommendation data store 110 shown in FIG. 1. In certain embodiments, the recommendation generation service module 112 can be associated with or otherwise implemented by the RTIS engine 103, and in other embodiments, may be implemented by a standalone component or processor.

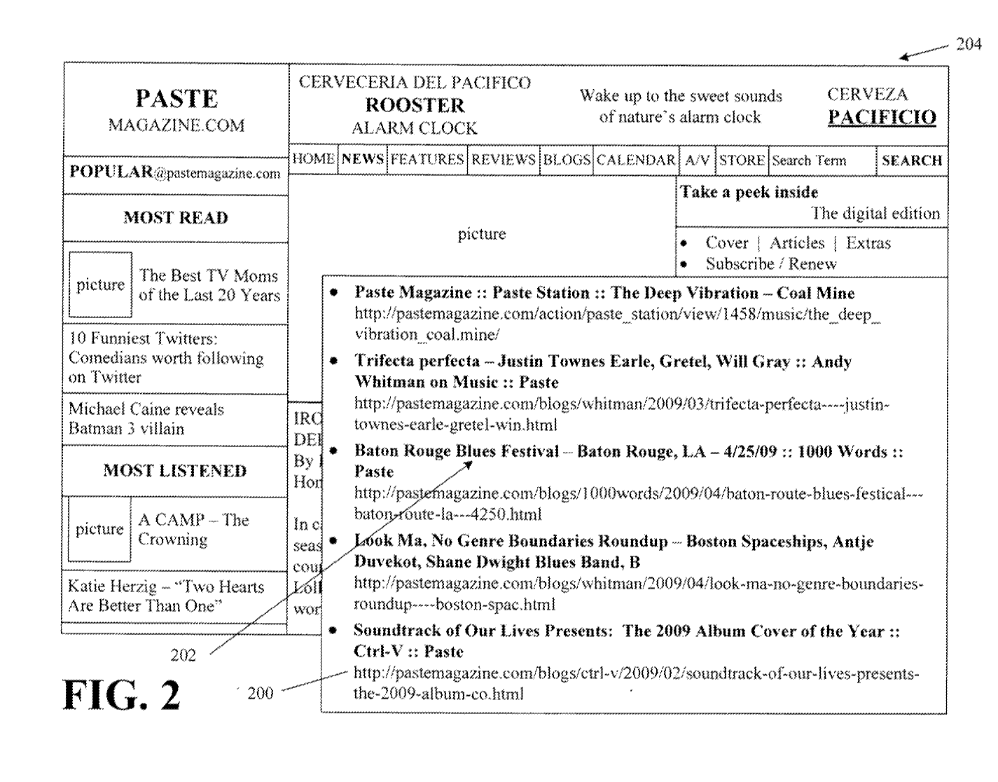

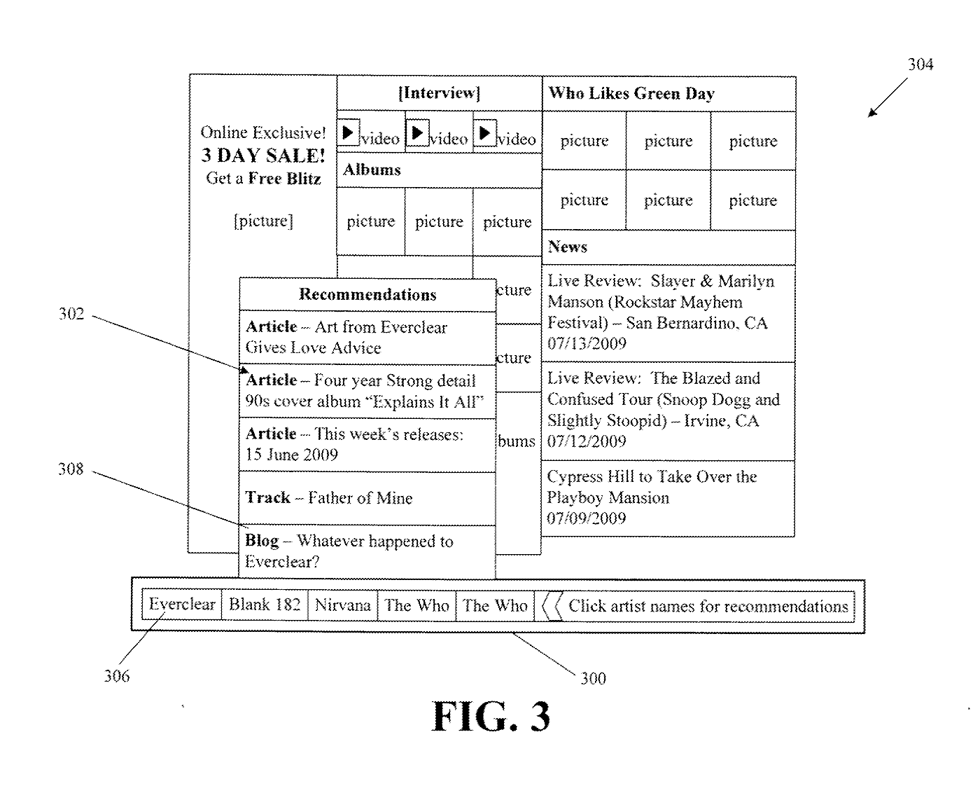

In certain embodiments, the RTIS engine such as 103 can utilize machine learning to continuously interpret, for each subject, whether contextual, behavioral, or network influenced recommendations should be displayed to visitors. Based at least in part on an automated analysis, the RTIS engine such as 103 can determine where the best possible content is located for each subject(s) based on the performance of pages containing those subject(s) and bring that content into a visitors recommendation display—whether that is onsite content from the website the visitor is viewing, or content from another vertical network member with the Javascript™ tag. Any number of presentation formats or outputs can be used to display content related information and links, for example, in-text and in-page components, direct integration with a content management system, or a dynamic navigation toolbar that customizes subjects and content recommendations based on each webpage a visitor navigates to. Example presentation formats or outputs are illustrated in FIGS. 2 and 3 described below.

One or more delivery recommendations generated by the RTIS engine such as 103 can be stored in a data storage device, such as a recommendation data store 110. In the embodiment shown in FIG. 1, a recommendation delivery (RD) module or application 114 can continually generate or otherwise provide new and/or updated delivery recommendations based on new and/or updated data from the RTIS engine 103. The new and/or updated delivery recommendations can also be stored in a data storage device, such as a recommendation data store 110 shown in FIG. 1. In certain embodiments, the recommendation delivery module or application 114 can be associated with or otherwise implemented by the RTIS engine such as 103, and in other embodiments, may be implemented by a standalone component or processor.

In certain embodiments, the RTIS engine such as 103 can collect relatively popular or “fast moving” content from one or more customers within a particular vertical, and can re-distribute that content to consumers who may most likely consume, read, or otherwise be interested in that content based on prior behavior or consumption patterns. In this manner, websites with exceptional content, as defined by normalized network trends such as average subject engagement, average time spent per word on page (containing the subject), or average page views per visit, can improve monetization of that content through new channels or websites with whom they have no pre-existing business or technology relationship with. Concurrently, the RTIS engine such as 103 can allow websites that need additional content (based on trends identified by network data with respect to specific subjects or behaviors) to keep users on their website longer by creating new page inventory comprised of content which the RTIS engine 103 predicts will be consumed, read, or otherwise be interested by those consumers.

When creating subject level recommendations, the RTIS engine such as 103 can account for any number of factors, for instance, four categories of factors such as visitor data (e.g., IP (Internet protocol) location and past pages and subjects visited), website trend data (data specific to an individual website), network data about the subject (trend data), and related subjects from one or more previously stored subject dictionaries and network analysis of content. In certain instances, the RTIS engine such as 103 can build a profile on each subject that is tracked, and using machine learning techniques, the RTIS engine 103 can determine which of these factors may play a greater or optimum role in making recommendations consumers are most likely to click on or otherwise respond to. In this manner, as network traffic and the number of recommendations or syndication increases, recommendation accuracy should increase.

When displaying recommendations via one or more client devices or output devices, the recommendation delivery tag 116 shown in FIG. 1 loads JavaScript™ which gets recommendations from the recommendation delivery module or application 114. Specifically, after a webpage with the recommendation delivery tag 116, such as a tracking tag, is loaded by a consumer's Internet browser program, the tracking tag will load additional client side JavaScript™ in the background after or as the webpage has or is fired. Some or all of the JavaScript™ can alter or otherwise modify the client's webpage by providing, for example, three components: a selected presentation device (such as shown in FIGS. 2 and 3 which demonstrate an example in-text, in-page content box 200, and a dynamic or predictive navigation bar 300), a style sheet, and a dataset. Based at least in part on which type of presentation device a user or client has previously selected, at least one type of style sheet to load can be selected. The selected style sheet can then be used to format the presentation of the dataset, which can include objects such as recommended URL's, URL titles, advertisements, subjects, subject rankings, or any other data available from the recommendation data store 110. The user or client's webpage can then be altered or otherwise modified to include the selected presentation device and one or more style sheets, which can display one or more recommendations on the user's or client's webpage.

When generating recommendations, the RTIS engine such as 103 can ingest URLs for each possible page recommendation, categorize the webpage from a standard list of categories for each vertical (e.g., video: track, editorial, blog post, etc.), and perform any cleansing as needed based at least in part on one or more predefined rules, such as stripping out a website's name if it is included in every URL from that site. In certain embodiments, a RTIS engine such as 103, using a parser and cleansing (P&C) component or module, can prepare a list of candidate URL recommendations for each subject the RTIS engine 103 has located.

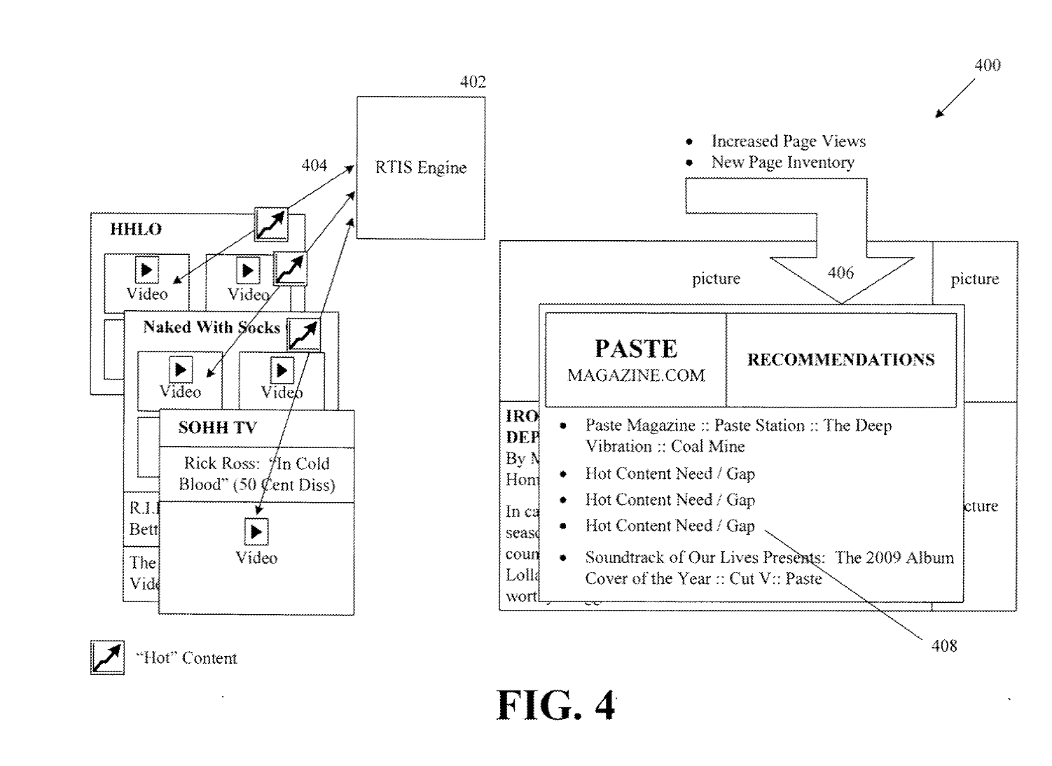

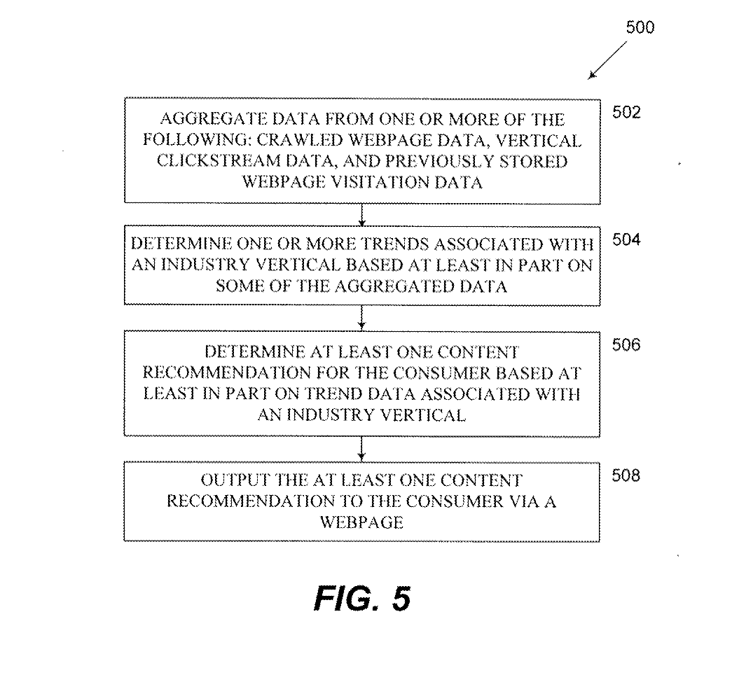

Embodiments of a data flow, such as 100A, can be implemented with a promotion delivery/targeting system such as 100B according to embodiments of the invention. A promotion delivery/targeting system 100B and associated functionality can be implemented with the data flow components described in FIG. 1, or other components as well as certain components of the systems described in FIG. 6 as well as co-pending U.S. application Ser. No. 12/367,968. Associated methods, processes, and associated sub-processes for providing targeted content are described by reference to FIGS. 4 and 5.

FIGS. 2-3 illustrate example presentations of data or output in accordance with certain embodiments of the invention. In FIG. 2, an example output generated by a real time syndication (RTIS) engine or application program similar to 103 in FIG. 1 is shown. For example, the output can be an in-text content box 200 or similar tool, which provides targeted content 202 of interest from the RTIS engine such as 103 to a user or consumer within the text of an example webpage 204 the user or consumer is viewing. In the example shown, when a user or consumer navigate's to a certain webpage or otherwise manipulates an indicator adjacent to or over certain webpage content, an in-text content box 200 or other similar tool can be presented or otherwise output adjacent to the indicator or over a portion of the webpage 204, and can provide one or more recommendations or targeted content 202. As described in the data flow 100A in FIG. 1, the RTIS engine 103 can generate one or more recommendations and output the recommendations via a selected presentation device, such as the in-text content box 200, on a webpage the user or consumer is viewing via a client device or an output device.

In FIG. 3, another example output generated by a real time syndication (RTIS) engine or application program similar to 103 in FIG. 1 is shown. For example, the output can be a dynamic or predictive navigation bar 300 or other similar bar or tool, which provides targeted content 302 of interest to a user or consumer adjacent to the text of an example webpage 304 the user or consumer is viewing. In the example shown, when a user or consumer manipulates the dynamic navigation bar 300, and selects a particular artist 306 or other category of information, a window 308 or other similar tool can be presented or otherwise output adjacent to the selected artist 306, and can provide one or more recommendations or targeted content 302. As described in the data flow 100A in FIG. 1, the RTIS engine 103 can generate one or more recommendations and output the recommendations via a selected presentation device, such as the dynamic navigation bar 300, on a webpage the user or consumer is viewing via a client device or an output device.

FIG. 4 illustrates another example data flow 400 in accordance with an embodiment of the invention. As shown in the embodiment of FIG. 4, a real time syndication (RTIS) engine 402 or application program similar to 103 in FIG. 1 can receive certain identified content 404 from a plurality of websites in a predefined vertical. For example, the RTIS engine 402 can receive relatively popular or “fast moving” content, as it pertains to one or more specific topics, from one or more customers within a particular vertical based at least in part on normalized network measures such as change in page views for the subject, or any other normalized subject measure the engine 402 or associated system component may track. Based at least in part on, for example, contextual and behavioral information as well as cross-site measurement of individual subjects, the RTIS engine 402 can determine and recommend certain targeted content 406 for particular customers. For instance, the RTIS engine 402 can redistribute or otherwise target, certain content to particular consumers who may most likely consume, read, or otherwise be interested in that content based on prior behavior or consumption patterns of that content. The RTIS engine 402 can then generate an output 408 or presentation of the targeted content 404 in any number of graphical views, such as in-text content shown in FIG. 2 or a dynamic or predictive navigation bar shown in FIG. 3.

For example, in the case of the death of Michael Jackson, the RTIS engine 402 may identify an increase in consumption of news articles referencing Michael Jackson that were published within a predefined time, such as the last few hours. The RTIS engine 402 may use this information to bias or otherwise weight certain recommendations. Thus, webpages that contain content related to Michael Jackson, his music or industry affiliations may be weighted less than the most engaging or popular and recent Michael Jackson news stories in a particular network. As the consumer interest in Michael Jackson's death wanes, the RTIS engine 402 may identify increased consumer interest in reviews of a behind-the-scenes Michael Jackson movie, such as “This is It,” as it nears public release. The RTIS engine 402 can then generate one or more recommendations including recent Michael Jackson movie reviews instead of previously recommending news articles.

In this manner, websites with content in demand by consumers on other sites in the network, as defined by normalized network trends such as average engagement with pages containing subjects or average page views per visit, can improve monetization of that content through new channels or websites with whom they have no technology nor business relations with. Concurrently, the RTIS engine such as 402 can allow websites that need additional content (based on specific behavioral and contextual analysis of the consumer on that site and the other similar consumers across fife network) to keep users on their websites longer by creating new page inventory comprised of content which the RTIS engine 402 predicts or otherwise determines will be consumed, read, or otherwise be interested by those consumers.

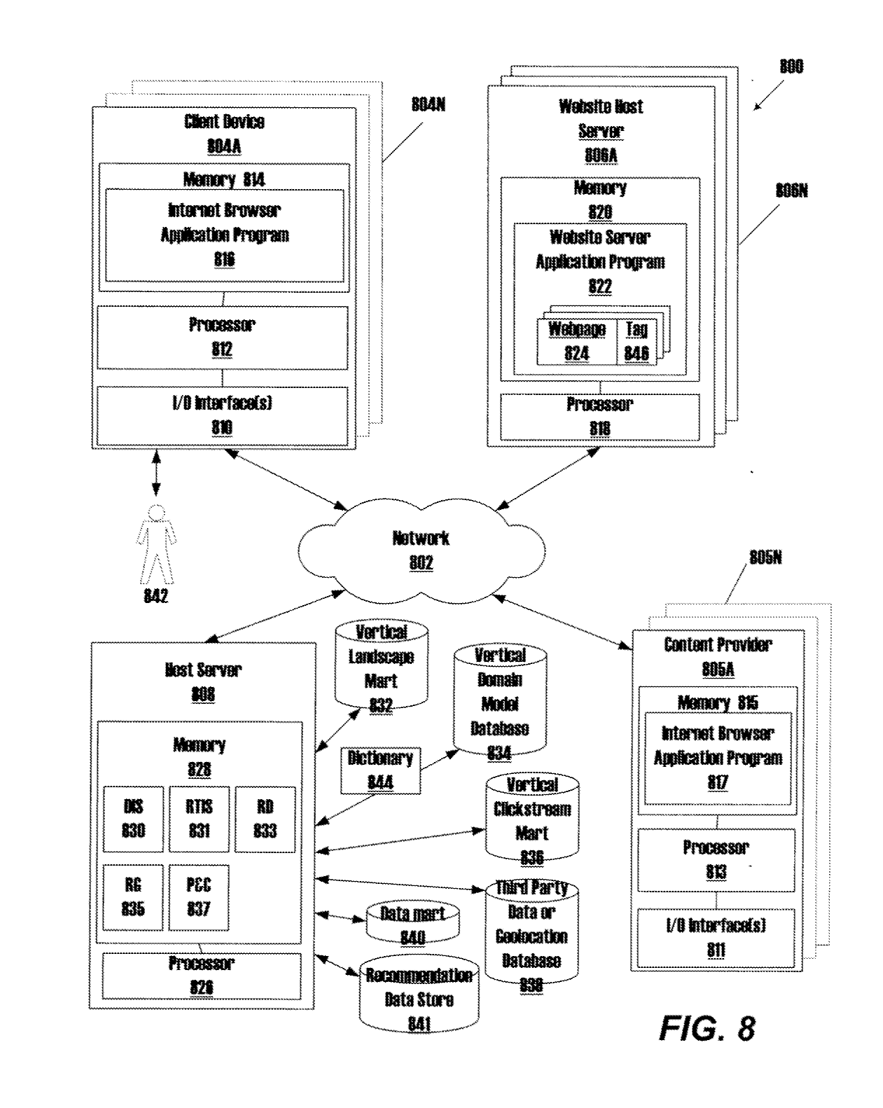

Embodiments of a data flow, such as 400, can be implemented with a promotion delivery/targeting system similar to 100B in FIG. 1 according to embodiments of the invention. The data flow 400 of FIG. 4 can also be implemented with the components of the system described in FIG. 8, or other components as well as certain components of the systems described in co-pending U.S. application Ser. No. 12/367,968.

The following FIGS. 5-7 illustrate example methods according to embodiments of the invention.

FIG. 5 illustrates an example method for providing targeted content to a network user according to an embodiment of the invention. The method 500 begins at block 502.

In block 502, the data is aggregated from one or more of the following: crawled webpage data, vertical clickstream data, and previously stored webpage visitation data. In the embodiment shown in FIG. 5, a processor such as 826 in FIG. 8 and/or a data integration service module or engine such as 830 can aggregate data from one or more of the following: crawled webpage data, vertical clickstream data, and previously stored webpage visitation data. In particular, data from databases or other data sources similar to 832, 834, 836, 838, 841, and 844 can be aggregated.

Block 502 is followed by block 504, in which one or more trends associated with an industry vertical is determined based at least in part on some of the aggregated data. In the embodiment shown in FIG. 5, the processor such as 826 in FIG. 8 and/or the data integration service module or engine such as 830 can determine one or more trends associated with an industry vertical based at least in part on some of the aggregated data.

Block 504 is followed by block 506, in which at least one content recommendation for the consumer is determined based at least in part on trend data associated with an industry vertical. In the embodiment shown in FIG. 5, the processor such as 826 in FIG. 8 and/or the data integration service module or engine such as 830 can determine at least one content recommendation for the consumer based at least in part on trend data associated with an industry vertical.

In one aspect of an embodiment, the trend data can comprise at least one of the following: popular or fast moving content in a vertical of interest, change in webpage view numbers for a subject of interest, average engagement with webpages containing subjects of interest, average webpage views per visit, a normalized network metric, or a normalized subject measure.

Block 506 is followed by block 508, in which the at least one content recommendation is output to the consumer via a webpage. In the embodiment shown in FIG. 5, the processor such as 826 in FIG. 8 and/or the data integration service module or engine such as 830 can output the at least one content recommendation to the consumer via a webpage.

In another aspect of an embodiment, the at least one content recommendation is output to the consumer via the webpage by at least one of the following: a pop-up window, a navigation bar, or a dedicated region of the webpage.

The method 500 ends after block 508.

FIG. 6 illustrates another example method for providing targeted content to a network user according to an embodiment of the invention. The method begins at block 602.

In block 602, behavioral data associated with network use by a plurality of users is received. In the embodiment shown in FIG. 6, a processor such as 826 in FIG. 8 and/or a data integration service module or engine such as 830 can receive behavioral data associated with network use by a plurality of users.

Block 602 is followed by block 604, in which contextual data associated with network use by the plurality of users' network use is received. In the embodiment shown in FIG. 6, a processor such as 826 in FIG. 8 and/or a data integration service module or engine such as 830 can receive contextual data associated with network use by the plurality of users' network use.

Block 604 is followed by block 606, in which at least one trend within a vertical is identified based at least in part on the behavioral data and the contextual data. In the embodiment shown in FIG. 6, a processor such as 826 in FIG. 8 and/or a data integration service module or engine such as 830 can identify at least one trend within a vertical is identified based at least in part on the behavioral data and the contextual data.

In one aspect of the an embodiment, identifying at least one trend within a vertical can include normalizing content from one or more vertically related websites using at least one dictionary.

In one aspect of the an embodiment, identifying at least one trend within a vertical can include implementing at least one machine based learning algorithm.

Block 606 is followed by block 608, in which a recommendation for at least one of the plurality of users is determined, wherein the recommendation comprises content from a webpage accessible via the network. In the embodiment shown in FIG. 6, a processor such as 826 in FIG. 8 and/or a data integration service module or engine such as 830 can determine a recommendation for at least one of the plurality of users, wherein the recommendation can include content from a webpage accessible via the network.

The method 600 ends after block 608.

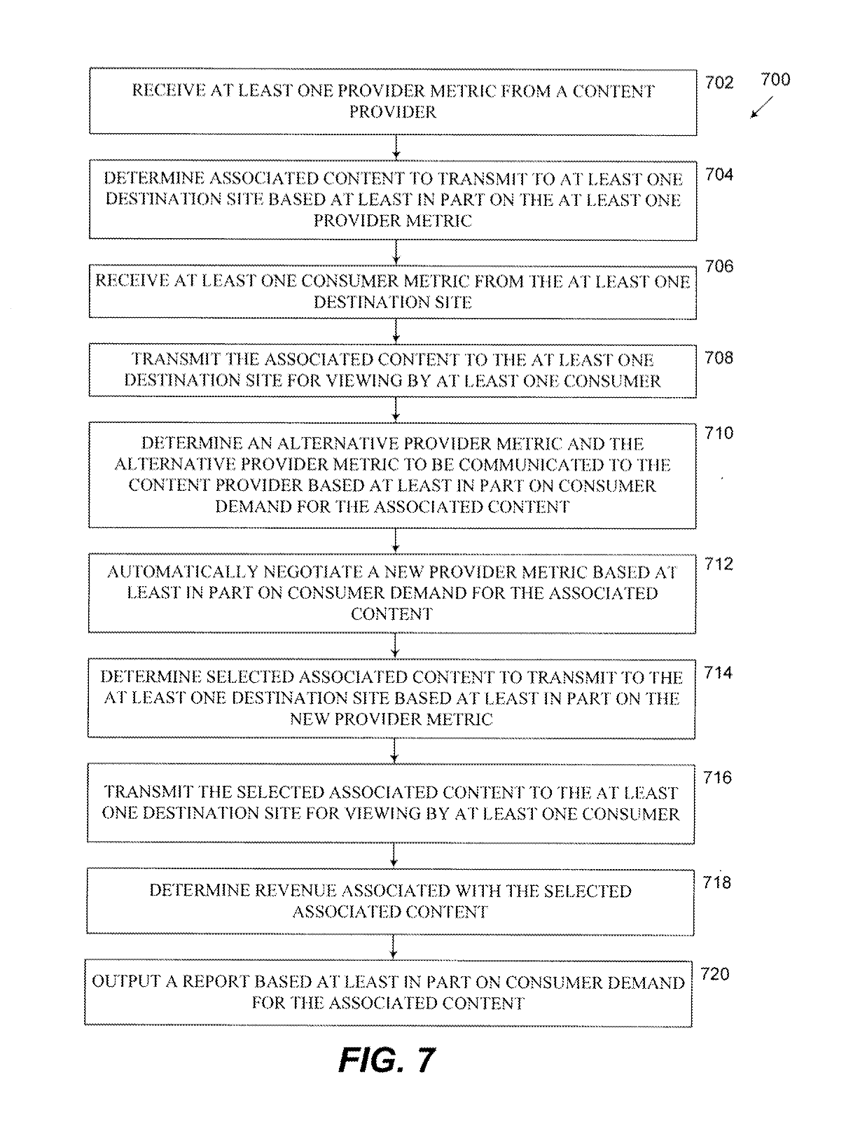

FIG. 7 illustrates another example method for providing targeted content to a network user according to an embodiment of the invention. The method 700 begins at block 702.

In block 702, at least one provider metric is received from a content provider. In the embodiment shown in FIG. 7, a processor such as 826 in FIG. 8 and/or a real time syndication module or engine such as 831 can receive at least one provider metric from a content provider.

Block 702 is followed by block 704, in which based at least in part on the at least one provider metric, associated content is determined to transmit to at least one destination site. In the embodiment shown in FIG. 7, a processor such as 826 in FIG. 8 and/or a real time syndication module or engine such as 831 can determine associated content to transmit to at least one destination site based at least in part on the at least one provider metric.

Block 704 is followed by optional block 706, in which at least one consumer metric is received from the at least one destination site. In the embodiment shown in FIG. 7, a processor such as 826 in FIG. 8 and/or a real time syndication module or engine such as 831 can receive at least one consumer metric from the at least one destination site. In this embodiment, determining associated content to transmit to at least one destination site can be further based at least in part on comparing the at least one provider metric with the at least one consumer metric.

In one aspect of an embodiment, consumption patterns within a network as well as results from past recommendations can be utilized to make recommendations to a consumer on a given destination site's page. The recommended content can be selected from the entire pool of content in our network, including the destination site's own content. Hence, the best content can be selected from the network for each consumer on each site in the network. Using dictionaries for each network of sites carrying related content, data can be normalized from disparate sites containing similar content. This normalization of data from sites carrying similar content permits analysis of relatively larger data sets than any one site has access to and thereby improves prediction and content recommendations over other conventional methods and systems.

Once content is identified for syndication both the content owner and the site receiving content have control over what content is syndicated, the price paid or received, the format of the content, and duration for which the content can be displayed. For example, CNN may set up rules regarding exactly which sites may carry its content, what price must be paid (CPM), what branding must remain on the content (CNN name, byline, etc), and the duration for which that content can be displayed. Similarly, CNN can set up rules or conditions regarding its receipt of content from others in the network including, what sites they will accept content from, the type of content they are willing to receive, the format of the content, the price they are willing to pay, and the duration for which they will display this syndicated content. In certain instances content may be syndicated only by and between sites when the rules or conditions of both the content owner (syndicator) and destination site (Syndicatee or publisher) are satisfied.

In at least one aspect of this embodiment, the at least one provider metric can include, but is not limited to, an attribution, a price, a rate, a duration, a location, a content licensing term, or at least one business rule.

In at least one aspect of this embodiment, the at least one consumer metric can include, but is not limited to, an attribution, a price, a rate, a duration, a location, a content licensing term, or at least one business rule.

Block 706 is followed by block 708, in which the associated content is transmitted to the at least one destination site for viewing by at least one consumer. In the embodiment shown in FIG. 7, a processor such as 826 in FIG. 8 and/or a real time syndication module or engine such as 831 can transmit the associated content to the at least one destination site for viewing by at least one consumer.

In one aspect of this embodiment, the associated content is transmitted to the at least one destination site by at least one of the following: a pop-up window, a navigation bar, or a dedicated region of at least one webpage.

Block 708 is followed by optional block 710, in which based at least in part on consumer demand for the associated content, an alternative provider metric can be determined and the alternative provider metric can be communicated to the content provider. In the embodiment shown in FIG. 7, a processor such as 826 in FIG. 8 and/or a real time syndication module or engine such as 831 can determine an alternative provider metric based at least in part on consumer demand for the associated content, and communicate that metric to the content provider.

Block 710 is followed by optional block 712, in which based at least in part on consumer demand for the associated content, a new provider metric can be automatically negotiated. In the embodiment shown in FIG. 7, a processor such as 826 in FIG. 8 and/or a real time syndication module or engine such as 831 can automatically negotiate a new provider metric based at least in part on consumer demand for the associated content.

In one example embodiment, a content owner “CO” may specify one or more tiered pricing rules for an article on swine flu. For example, CO specifies a desired rate of $1.00 for every thousand views (CPM) of an article if the article cleansed of any reference of the source, link backs or facilitates advertising. Similarly, CO will sell the article for $0.20 CPM if a byline and a link back is shown with the article. Lastly, CO will pay the DS $2.00 CPM (or charge nothing) if it is allowed to show an advertisement(s) within the article on the DS site. In parallel, the DS specifies it will only pay $0.90 for appropriate content cleansed content but it will pay $0.30 CPM for content with a byline. Hence, content from CO may be displayed on DS sites for a $0.30 CPM.

Block 712 is followed by optional block 714, in which based at least in part on the new provider metric, selected associated content can be determined to transmit to the at least one destination site. In the embodiment shown in FIG. 7, a processor such as 826 in FIG. 8 and/or a real time syndication module or engine such as 831 can determine selected associated content to transmit to the at least one destination site based at least in part on the new provider metric.

Block 714 is followed by optional block 716, in which the selected associated content is transmitted to the at least one destination site for viewing by at least one consumer. In the embodiment shown in FIG. 7, a processor such as 826 in FIG. 8 and/or a real time syndication module or engine such as 831 can transmit the selected associated content to the at least one destination site for viewing by at least one consumer.

Block 716 is followed by optional block 718, in which revenue associated with the selected associated content can be determined. In the embodiment shown in FIG. 7, a processor such as 826 in FIG. 8 and/or a real time syndication module or engine such as 831 can determine revenue associated with the selected associated content.

In one aspect of an embodiment, after posting of the selected associated content by the at least one destination site, revenue associated with the selected associated content can be determined for transmission to either an account associated with the content provider or to an account associated with the at least one destination site.

Block 718 is followed by optional block 720, in which based at least in part on consumer demand for the associated content, a report can be output. In the embodiment shown in FIG. 7, a processor such as 826 in FIG. 8 and/or a real time syndication module or engine such as 831 can output a report based at least in part on consumer demand for the associated content.

In one aspect of an embodiment, based at least in part on consumer demand for the associated content, a report can be output to the content provider with at least one recommendation for increasing consumer demand for the associated content.

In one aspect of an embodiment, one or more reports can be output or otherwise automatically generated which provide both DS and CO with guidance regarding the impact of changing rules pertaining to syndications. Using the above example, CO can be presented with a report predicting how many more page views their content would received if it were priced at $0.25 CPM instead of $0.30 CPM. Likewise, the DS can receive a similar report predicting how many more page views that would have received if they were willing to pay $2.00 CPM for syndicated content. Likewise, there reports can predict the relative impact of changes to other business rules and guide the DS and CO how to maximize profit, distribution, or page views. Finally, certain embodiments can automatically output or otherwise generate reports detailing, for example, the content that has been syndicated, where it was syndicated, the total number of page views, and all monies owed to or by CO and DS.

The method 700 of FIG. 7 ends after block 720.

Embodiments of the example methods 500, 600, 700 shown in FIGS. 5, 6, and 7 can be implemented with a promotion delivery/targeting system or real-time syndication engine according to embodiments of the invention. A promotion delivery/targeting system or real-time syndication engine and associated functionality can be implemented with the data flow components described in FIGS. 1 and 4, certain components of the system described in FIG. 8 as well as certain components of the systems described in co-pending U.S. application Ser. No. 12/367,968. The example embodiments of FIGS. 5, 6, and 7 can have fewer or greater numbers of elements according to other embodiments of the invention.

FIG. 8 illustrates an example environment and system in accordance with an embodiment of the invention. In this example, the environment can be a client-server configuration, and the system can be a promotion delivery/targeting system. The system 800 is shown with a communications network 802, such as the Internet, in communication with at least one client device 804A and at least one content provider 805A. Any number of other client devices 804N and content providers 805N can also be in communication with the network 802. The network 802 is also shown in communication with at least one website host server 806A or destination site. Any number of other website host servers 806N or destination sites can also be in communication with the network 802. In addition, the network 802 is also shown in communication with at least one host server 808. Any number of other host servers can also be in communication with the network 802.

The communications network 802 shown in FIG. 8 can be, for example, the Internet. In another embodiment, the network 802 can be a wireless communications network capable of transmitting both voice and data signals, including image data signals or multimedia signals. Other types of communications networks, including local area networks (LAN), wide area networks (WAN), a public switched telephone network, or combinations thereof can be used in accordance with various embodiments of the invention.

Each of the client devices 804A-804N is typically associated with an entity or person accessing or otherwise requesting content from a webpage or a website. Each client device 804A-804N can be a computer or processor-based device capable of communicating with the communications network 802 via a signal, such as a wireless frequency signal or a direct wired communication signal. A respective communication or input/output interface 810 associated with each client device 804A-804N can facilitate communications between the client device 804A-804N and the network 802 or Internet. Each client device, such as 804A, can include a processor 812 and a computer-readable medium, such as a random access memory (RAM) 814, coupled to the processor 812. The processor 812 can execute computer-executable program instructions stored in memory 814. Computer executable program instructions stored in memory 814 can include an Internet browser application program, such as 816. The Internet browser application program 816 can be adapted to access and/or receive one or more webpages 824 and associated content from at least one remotely located website host server, such as 806A.

Each of the content providers 805A-805N is typically associated with a third party entity or person that generates, collects, or otherwise facilitates distribution of content to consumers via a webpage or website. Each content provider 805A-805N can be associated with a computer or processor-based device capable of communicating with the communications network 802 via a signal, such as a wireless frequency signal or a direct wired communication signal. A respective communication or input/output interface 811 associated with each content provider 805A-805N can facilitate communications between the content provider 805A-805N and the network 802 or Internet. Each content provider, such as 805A, can include a processor 813 and a computer-readable medium, such as a random access memory (RAM) 815, coupled to the processor 813. The processor 813 can execute computer-executable program instructions stored in memory 815. Computer executable program instructions stored in memory 815 can include an Internet browser application program, such as 817. The Internet browser application program can be adapted to transmit one or more webpages and associated content from the one or more content providers 805A-605N as well as transmit or otherwise send content for one or more webpages 824 and any associated content to the one or more destination sites or website host servers 806A-806N.

Each destination site or website host server 806A-806N is typically associated with a third party entity or person, who may be associated or not associated with a content provider 805A-805N. In some instances, a destination site or website host server 806A-806N could be associated with a news media outlet. In other instances, a destination site or website host server 806A-806N could be associated with an independent blog. Each destination site or website host server 806A-806N can be a computer or processor-based device capable of communicating with the communications network 802 via a signal, such as a wireless frequency signal or a direct wired communication signal. Each destination site or website host server, such as 806A, can include a processor 818 and a computer-readable medium, such as a random access memory (RAM) 820, coupled to the processor 818. The processor 818 can execute computer-executable program instructions stored in memory 820. Computer executable program instructions stored in memory 820 can include a website server application program, such as 822. The website server application program 822 can be adapted to receive one or more webpages 824 and any associated content from the one or more content providers 805A-805N as well as serve or otherwise facilitate access to one or more webpages 824 and any associated content to the one or more client devices 804A-804N and content providers 805A-805N.

The host server 808 can be a computer or processor-based device capable of communicating with the communications network 802 via a signal, such as a wireless frequency signal or a direct wired communication signal. The host server 808 can include a processor 826 and a computer-readable medium, such as a random access memory (RAM) 828, coupled to the processor 826. The processor 826 can execute computer-executable program instructions stored in memory 828. Computer executable program instructions stored in memory 828 can include a data integration services (DIS) module or engine, such as 830; a promotion delivery/targeting or real time syndication (RTIS) module or engine, such as 831; a recommendation delivery (RD) module or application, such as 833; a recommendation generation (RG) service module or application, such as 835; and a parsing and cleaning (P&C) module or application, such as 837. In any instance, the associated computer executable program instructions including the data integration services (DIS) module or engine 830 can be adapted to receive and/or collect various data from any number of client devices 804A-804N, content providers 805A-805N, destination sites or website host servers 806A-806N, and databases or data storage devices, such as 832, 834, 836, 838, 840, and 841. The associated computer executable program instructions including the data integration services (DIS) module or engine 830 can be further adapted to transform, aggregate, or otherwise normalize some or all of the received and/or collected data according to any number of predefined algorithms or routines.

Generally, each of the memories 814, 815, 820, 828, and data storage devices 832, 834, 836, 838, 840, and 841 can store data and information for subsequent retrieval. In this manner, the system 800 can store various received or collected information in memory associated with a client device, such as 804A, a content provider, such as 805A, a destination site or website host server, such as 806A, a host server 808, or a database, such as 832, 834, 836, 838, 840, and 841. The memories 814, 815, 820, 828, and databases 832, 834, 836, 838, 840, and 841 can be in communication with other databases, such as a centralized database, or other types of data storage devices. When needed, data or information stored in a memory or database may be transmitted to a centralized database capable of receiving data, information, or data records from more than one database or other data storage devices. The databases 832, 834, 836, 838, 840, and 841 shown in FIG. 8 include, but are not limited to, a vertical landscape mart 832, a vertical domain model database 834, a vertical clickstream mart 836, a third party data or geolocation database 838, a data mart 840, and a recommendation data store 841. In other embodiments, some or all of the databases can be integrated or distributed into any number of databases or data storage devices.

Suitable processors for a client device 804A-804N, a content provider 805A-805N, a destination site or website host server 806A-806N, and a host server 808 may comprise a microprocessor, an ASIC, and state machines. Example processors can be those provided by Intel Corporation and Motorola Corporation. Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor, such as the processor 812, 813, 818, or 826, with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C++, C#, Visual Basic, Java, Python, Peri, and JavaScript.

Client devices 804A-804N may also comprise a number of other external or internal devices such as a mouse, a CD-ROM, DVD, a keyboard, a display, or other input or output devices. As shown in FIG. 8, a client device such as 804A can be in communication with an output device via a communication or input/output interface, such as 810. Examples of client devices 804A-804N are personal computers, mobile computers, handheld portable computers, digital assistants, personal digital assistants, cellular phones, mobile phones, smart phones, pagers, digital tablets, desktop computers, laptop computers, Internet appliances, and other processor-based devices. In general, a client device, such as 804A, may be any type of processor-based platform that is connected to a network, such as 802, and that interacts with one or more application programs. Client devices 804A-804N may operate on any operating system capable of supporting a browser or browser-enabled application including, but not limited to, Microsoft Windows®, Apple OSX™, and Linux. The client devices 804A-804N shown include, for example, personal computers executing a browser application program such as Microsoft Corporation's Internet Explorer™, Netscape Communication Corporation's Netscape Navigator™, and Apple's Safari™, and Mozilla Firefox™.

In one embodiment, suitable client devices can be standard desktop personal computers with Intel x86 processor architecture, operating a Microsoft® Windows® operating system, and programmed using a Java language.

Examples of content providers 805A-805N are servers, personal computers, mobile computers, handheld portable computers, digital assistants, personal digital assistants, cellular phones, mobile phones, smart phones, pagers, digital tablets, desktop computers, laptop computers, Internet appliances, and other processor-based devices. In general, a content provider, such as 805A-805N, may be any type of processor-based platform that is connected to a network, such as 802, and that interacts with one or more application programs.

Servers 806A and 808, each depicted as a single computer system, may be implemented as a network of computer processors. Examples of suitable servers are server devices, mainframe computers, networked computers, a processor-based device, and similar types of systems and devices.

A consumer, such as 842, can interact with a client device, such as 804A, via any number of input and output devices (not shown) such as an output display device, keyboard, and a mouse. Any number of content providers 805A-805N can provide associated content, such as original or third party owned images, pictures, documents, webpages, objects, sounds, files, and other electronic data via the network 802 to the destination site or website host server 806A-806N. In this manner, the consumer 842 can access one or more webpages 824 located on a destination site or website server host, such as 806A, via an Internet browser application program, such as 816, operating on a client device, such as 804A.

Instructions stored in either the host server processor 826 or the memory 828, or both, such as the data integration service module or engine 830, can initiate and aggregate some or all of the data streams from databases 832, 834, 836, 838, 840, and 841 or other data sources similar to 104, 106, and 108 described in FIG. 1. For example, in one embodiment, the processor 826 can implement a crawl or search of one or more webpages 824 stored on any number of website host servers 806A-806N. Job crawl data received by or otherwise collected by way of the crawl can be stored in a data storage device such as the vertical landscape mart 832 or similar database. By way of another example in one embodiment, the processor 826 can implement loading of one or more dictionaries 844 in a data storage device such as the vertical domain model database 834. In yet another example in one embodiment, the processor 826 can implement receiving click session data from one or more V-tags or tags 846 associated with any number of webpages 824 stored on at least one website host server, such as 806A, and being accessed or otherwise visited by at least one consumer, such as 842. The processor 826 can store the click session data in a data storage device such as the vertical clickstream mart 836 or similar database.

In the example embodiment shown, the processor 826 and/or data integration service module or engine 830 can be adapted to combine consumer session data with crawl job data, and store some or all of the data in a data storage device such as the data mart 840 or database. The processor 826 and/data integration service module or engine 830 can be adapted to normalize some or all of the received and/or collected data using any number of algorithms or routines. The data integration or vertical transformation process can also be adapted to perform contextual analysis of certain keywords to track consumer content consumption at the keyword level using vertical or industry-specific dictionaries of keywords.

In one aspect of an embodiment, a processor or data integration service module or engine 830 can utilize a third party data or geolocation database, such as 838, to determine third party data or location information associated with one or more URLs associated with a respective website, website host server address, network address, IP address, or client device IP address. The third party data or location information can also be utilized by the processor 826 or data integration service module or engine 830 to analyze, process, and filter some or all of the previously collected consumer session data with crawl job data.

Similar to the data flow 100A described in FIG. 1, the processor 826 and/or the data integration service module or engine 830 can aggregate data from one or more of the following: crawled webpage data, vertical clickstream data, and previously stored webpage visitation data. processor 826 and/or the data integration service module or engine 830. Based at least in part on some of the aggregated data, one or more trends associated with an industry vertical can be determined. Based at least in part on one or more trends associated with an industry vertical, at least one content recommendation for the consumer can be determined. Furthermore, the at least one content recommendation can be output to the consumer via the webpage.

In any instance, certain combinations of consumer session data, crawl job data and/or third party data can be transformed by a module or engine, such as 830, to representative data for providing targeted content for a network user.

In one aspect of an embodiment, the processor 826 and/or the real time syndication module or engine 831 can receive at least one provider metric from a content provider. Based at least in part on the at least one provider metric, associated content to transmit to at least one destination site can be determined. Furthermore, the associated content can be transmitted to the at least one destination site for viewing by at least one consumer.

In another aspect of an embodiment, the processor 826 and/or the real time syndication module or engine 831 can automatically negotiate and determine content to transmit to at least one destination site, such as a webpage 824 hosted by a website host server 806A. Based on one or more provider metrics from a content provider such as 805A, and one or more consumer metrics from a destination site, such as webpage 824, a determination of suitable content to transmit to the destination site, such as webpage 824, can be made.

In yet another aspect of an embodiment, the processor 826 and/or the real time syndication module or engine 831 can determine an alternative provider metric based at least in part on consumer demand for the associated content, and can communicate the alternative provider metric to the content provider such as 805A. In certain instances, based at least in part on consumer demand for the associated content, a new provider metric can be automatically negotiated by the processor 826 and/or the real time syndication module or engine 831. Based at least in part on the new provider metric, selected associated content can be determined to transmit to the at least one destination site, such as a webpage 824 hosted by a website host server 806A, for viewing by at least one consumer, such as 842 via a client device such as 804A.

The system 800 can output or otherwise display one or more reports for a user via an output device, such as a printer, associated with a client device 804A-804N or host server 808. In one embodiment, consumer behavior with respect to a predefined keyword can be printed on an output device, such as a printer (not shown), associated with a client device, such as 804A, for a user's benefit or consumption. In another embodiment, consumer behavior with respect to a predefined keyword can be displayed on an output device, such as a display (not shown), associated with a client device, such as 804A, for a user. In other embodiments, various consumer responses and demands with respect to certain metrics can be displayed on an output device, such as a display (not shown), associated with a content provider, such as 805A, or a client device, such as 804A, for a user. Suitable types of output devices for users can include, but are not limited to, printers, printing devices, output displays, and display screens. Thus, both content providers and destination sites can receive and analyze reports based on any number of provider metrics and/or consumer metrics, and consumer demand for associated content and/or selected associated content provided to destination sites.

One may recognize the applicability of embodiments of the invention to other environments, contexts, and applications. One will appreciate that components of the system 800 shown in and described with respect to FIG. 8 are provided by way of example only. Numerous other operating environments, system architectures, and device configurations with fewer or greater numbers of elements are possible. Accordingly, embodiments of the invention should not be construed as being limited to any particular operating environment, system architecture, or device configuration.

Embodiments of a system, such as 800, can facilitate providing targeted content for a network user. Unexpected improvements in providing targeted content for a network user can be achieved by way of various embodiments of the system 800 described herein. Example data flows, methods, and processes which can be implemented with the example system 800 are described by reference to FIGS. 1, 4, 5, 6, and 7.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for providing targeted content to a consumer via a network during the consumer's viewing of a webpage, the method comprising:
aggregating data from one or more of the following: crawled webpage data, vertical clickstream data, and previously stored webpage visitation data;
based at least in part on some of the aggregated data, determining one or more trends associated with an industry vertical;
based at least in part on one or more trends associated with an industry vertical, determining at least one content recommendation for the consumer; and
outputting the at least one content recommendation to the consumer via the webpage.

2. The method of claim 1, wherein aggregating data comprises normalizing content from one or more vertically related websites using at least one dictionary.

3. The method of claim 1, wherein determining at least one content recommendation for the consumer comprises implementing at least one machine based learning algorithm.

4. The method of claim 1, wherein the one or more trends comprise at least one of the following: popular or fast moving content in a vertical of interest, change in page view numbers for a subject of interest, average engagement with webpages containing subjects of interest, average webpage views per visit, a normalized network metric, or a normalized subject measure.

5. The method of claim 1, wherein the at least one content recommendation is output to the consumer via the webpage by at least one of the following: a pop-up window, a navigation bar, or a dedicated region of the webpage.

6. A system for providing targeted content to a consumer via a network during the consumer's online use of a webpage, the system comprising one or more processors operable to execute instructions to:
aggregate data from one or more of the following: crawled webpage data, vertical clickstream data, and previously stored webpage visitation data;
based at least in part on some of the aggregated data, determine one or more trends associated with an industry vertical;
based at least in part on some of the one or more trends, determine at least one content recommendation for the consumer; and
output the at least one content recommendation to the consumer via a webpage.

7. A method for providing targeted content to a customer via a network, the method comprising:
receiving behavioral data associated with network use by a plurality of users;
receiving contextual data associated with network use by the plurality of users' network use;
based at least in part on the behavioral data and the contextual data, identifying at least one trend within a vertical; and
determining a recommendation for at least one of the plurality of users, wherein the recommendation comprises content from a webpage accessible via the network.

8. The method of claim 7, wherein identifying at least one trend within a vertical comprises normalizing content from one or more vertically related websites using at least one dictionary.

9. The method of claim 7, wherein identifying at least one trend within a vertical comprises implementing at least one machine based learning algorithm.

10. A method for providing targeted content to a customer via a network, the method comprising:
receiving at least one provider metric from a content provider;
based at least in part on the at least one provider metric, determining associated content to transmit to at least one destination site; and
transmitting the associated content to the at least one destination site for viewing by at least one consumer.

11. The method of claim 10, wherein determining associated content to transmit to at least one destination site comprises:
aggregating data from one or more of the following: crawled webpage data, vertical clickstream data, and previously stored webpage visitation data; and
implementing at least one machine-based learning algorithm with some or all of the aggregated data.

12. The method of claim 10, further comprising:
receiving at least one consumer metric from the at least one destination site;
wherein determining associated content to transmit to at least one destination site is further based at least in part on comparing the at least one provider metric with the at least one consumer metric.

13. The method of claim 12, wherein the at least one provider metric or consumer metric comprises at least one of the following: an attribution, a price, a rate, a duration, a location, a content licensing term, or at least one business rule.

14. The method of claim 10, further comprising:
based at least in part on consumer demand for the associated content, determining an alternative provider metric and communicating the alternative provider metric to the content provider.

15. The method of claim 10, further comprising:
based at least in part on consumer demand for the associated content, automatically negotiating a new provider metric;
based at least in part on the new provider metric, determining selected associated content to transmit to the at least one destination site; and
transmitting the selected associated content to the at least one destination site for viewing by at least one consumer.

16. The method of claim 10, wherein the associated content is transmitted to the at least one destination site by at least one of the following: a pop-up window, a navigation bar, or a dedicated region of at least one webpage.

17. The method of claim 15, further comprising:
upon posting of the selected associated content by the at least one destination site, transmitting revenue associated with the selected associated content to either an account associated with the content provider or to an account associated with the at least one destination site.

18. The method of claim 10, further comprising:
based at least in part on consumer demand for the associated content, outputting a report to the content provider with at least one recommendation for increasing consumer, demand for the associated content.

19. A system for providing targeted content to a consumer via a network, the system comprising:
a processor operable to execute computer-readable instructions; and
a memory comprising computer-readable instructions operable to:
receive at least one provider metric from a content provider;
based at least in part on the at least one provider metric, determine associated content to transmit to at least one destination site; and
transmit the associated content to the at least one destination site for viewing by at least one consumer.

20. The system of claim 19, wherein the computer-readable instructions are further operable to:
aggregate data from one or more of the following: crawled webpage data, vertical clickstream data, and previously stored webpage visitation data; and
implement at least one machine-based learning algorithm with some or all of the aggregated data.

21. The system of claim 19, wherein the computer-readable instructions are further operable to:
receive at least one consumer metric from the at least one destination site;
wherein determining associated content to transmit to at least one destination site is further based at least in part on comparing the at least one provider metric with the at least one consumer metric.

22. The system of claim 19, wherein the at least one provider metric or consumer metric comprises at least one of the following: an attribution, a price, a rate, a duration, a location, a content licensing term, or at least one business rule.

23. The system of claim 19, wherein the computer-readable instructions are further operable to:
based at least in part on consumer demand for the associated content, determine an alternative provider metric and communicate the alternative provider metric to the content provider.

24. The system of claim 19, wherein the computer-readable instructions are further operable to:
based at least in part on consumer demand for the associated content, automatically negotiate a new provider metric;
based at least in part on the new provider metric, determine selected associated content to transmit to the at least one destination site; and
transmit the selected associated content to the at least one destination site for viewing by at least one consumer.

25. The system of claim 19, wherein the associated content is transmitted to the at least one destination site by at least one of the following: a pop-up window, a navigation bar, or a dedicated region of at least one webpage.

26. The system of claim 19, wherein the computer-readable instructions are further operable to:
upon posting of the selected associated content by the at least one destination site, transmit revenue associated with the selected associated content to either an account associated with the content provider or to an account associated with the at least one destination site.

27. The system of claim 19, wherein the computer-readable instructions are further operable to:
based at least in part on consumer demand for the associated content, output a report to the content provider with at least one recommendation for increasing consumer demand for the associated content.
